(19) United States
(12) Patent Application Publication
(10) Pub. No.: US 2002/0017357 A1
(43) Pub. Date: Feb. 14, 2002

(54) Method for applying a tread band to a tire and a tread band applying apparatus

(76) Inventor: Florian Fischer, Ebersberg (DE)

Correspondence Address: ROBERT W. BECKER & ASSOCIATES, Suite B, 11896 N Highway 14, Tijeras, NM, 87059, US

(21) Appl. No.: 09/924,878

(22) Filed: Aug. 7, 2001

(30) Foreign Application Priority Data
Aug. 7, 2000 (DE) 100 38 471.4

(51) Int. Cl. B29C 35/00

(52) U.S. Cl. 156/111

(57) ABSTRACT

A method and apparatus for applying a tread band onto a tire carcass of a tire which is to be fabricated or a tire which is to be retreaded are provided and include feeding a tread band onto the tire carcass via a tread band feed device while the tire carcass is rotated and in conjunction with the pressing of the tread band against the tire carcass by a pressing device. The tread band has a shorter length before its application onto the tire carcass than its length following the application thereof onto the tire carcass. A tension force is exerted on the tread band via at least one clamp clamped on the rearward end of the tread band to produce thereby a constant tension in the tread band.

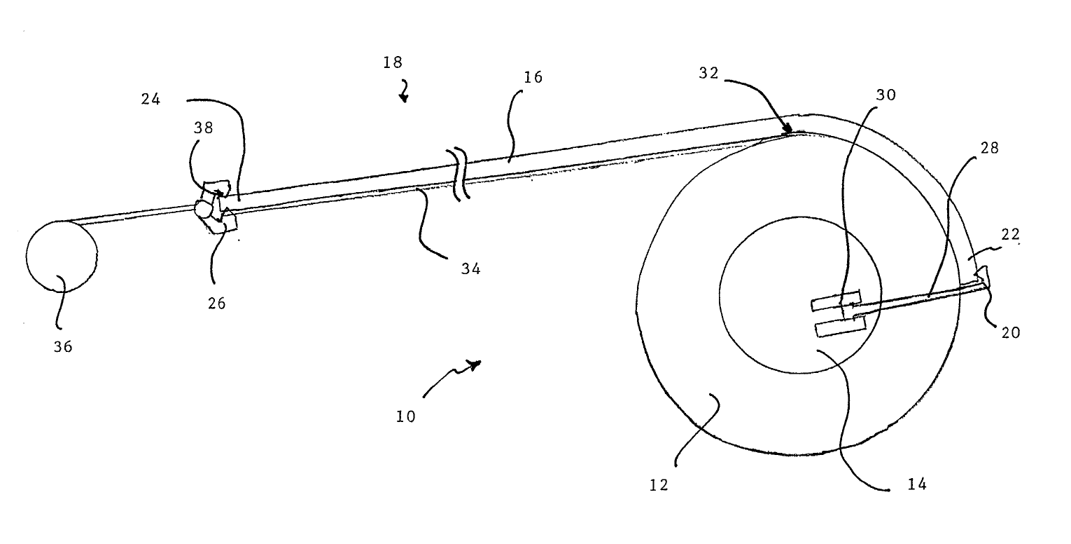

### BACKGROUND OF THE INVENTION

The present invention relates to a method for producing a tire as well as a method for applying a tread band to a tire in a retreading operation and the present invention additionally relates to a tread band applying apparatus.

A known tread band applying method and apparatus are disclosed in DE-OS 41 09 984. In accordance with this known method, a tread band is guided onto a carcass via a guide chute, whereby, at the beginning of the feed of the tread band onto the carcass, the tread band is placed under tension in that a spool is driven at a rotational speed less than the rotational speed of the carcass.

In this manner, a tread band having a length less than the circumference of the carcass is disposed onto the carcass. A disadvantage of this conventional method is that, at the beginning of the application of the tread band onto the carcass, a correspondingly large tension must be introduced in order to achieve the desired tread band application result. At the same time, this conventional approach results in a non-uniform thickness of the tread band along the circumference of the carcass, whereby it can be readily appreciated that this conventional approach has not been heretofore widely accepted.

There is, indeed, additionally provided a pressing device which presses the tread band onto the carcass and in this way promotes a certain uniformity of the tread band thickness. Such pressing devices are conventionally known and are also deployed in other situations in order to ensure a secure interconnection between tread bands and carcasses with the binding rubber layer which has previously been disposed either on the tread band or on the carcass, whereby, when the possibility exists, the tread band application is accomplished without the occurrence of included air pockets. A disadvantage of such pressing devices is that air can indeed penetrate into the tread band region such that included air remains in the shoulder region for the reason that no pressure or force is applied thereagainst during the tread band application process. On the other hand, the shoulder region is especially critical with respect to the separation of the tread surface from the carcass and, as well, the compressive working of the shoulder region is comparable to the compressive working of the tread surface itself.

A further disadvantage of the known pressing devices is that the pressure or force applied thereby causes displacement or offsetting of the neutral filaments or cords in the tread bands. In this manner, in the region of the binding rubber layer, a widening thereof is produced which is thereafter revised or adjusted as soon as the tread band leaves the region of the pressing device. In this manner, the tread bands work relative to the carcass in micro regions in the longitudinal direction thereof and this leads to a weakening of the interconnection between the carcass and the tread bands. Despite these disadvantages, numerous pressing devices are deployed for the reason, in fact, to ensure the required interconnection between the tread bands and the carcass.

### SUMMARY OF THE INVENTION

The present invention offers a solution to the challenge of providing a method for applying a tread band in connection with the fabrication of a tire or in connection with the retreading of a tire, as well as a solution to the challenge of providing a tread band applying apparatus, such that there is a relatively reduced tendency toward included air and such that there is the possibility for a uniform and qualitatively improved application of a tread band on a carcass.

In accordance with the present invention, it is especially advantageous that, during the application of a tread band, a tension is continuously and uniformly applied thereto which reliably prevents the inclusion of air without the need to deploy a pressing device in the tread band application process. The neutral filaments or cords are correspondingly disposed relatively closely adjacent to the binding rubber layer during the bending of the tread band so that no, or substantially no, material displacement occurs during the winding on of the tread band onto the carcass.

By virtue of the uniform tension across the entire length of the tread band, a uniform thickness of the tread band results without imbalance problems and without the necessity for follow up work, whereby the manufacturing costs of a tread band applied in accordance with the present invention are reduced.

In accordance with the present invention, it is particularly advantageous if the tread band is engaged at its ends by clamps, whereby the clamps which clamp the forward end of the tread band are supported on the carcass-supporting frame and turn in correspondence with rotation of the carcass. In contrast, the clamps which clamp the rearward end of the tread band move with the tread band as it is fed onto the rotating carcass during the tread application process. This corresponding clamp movement can be effected, for example, by a resilient biasing means which is configured either as a substantially long tension spring or a spiral spring which exerts a substantially constant spring force on the rearward end of the tread band during the winding up of the tread band onto the carcass.

It is particularly advantageous if the applied tension force is uniformly distributed along the tread band. In this manner, it is advantageous if at least two clamps extending over the width of the rearward end of the tread band as well as two clamps extending over the width of the forward end of the tread band are provided to thereby hold fast the tread band. In this manner, suitable configurations of the clamps are possible which can take into account the material properties of the tread band. For example, the clamps can also include a hook which penetrates or extends into the tread band or the tread band can be placed in tension by the pressing thereagainst of opposed press surfaces.

In accordance with the present invention, it is provided that the forward end of the tread band, at least during the beginning of the application of the tread band onto the carcass, is engaged by a clamp or a hook or the like to thereby secure the tread band to the carcass. The clamp can, for example, be supported from the carcass support frame, whereby it is to be understood that the clamping function of this clamp is no longer applied once the tread band has been wound halfway or further onto the carcass, as the binding rubber layer on the tread band thereafter secures the tread band to the carcass.

In one modification of the present invention, the rearward end of the tread band is held under tension in a monitored or controlled manner. By this measure, it can be ensured that the force is consistently applied at the same uniform value.

In accordance with the present invention, it is particularly advantageous that, at a contact point between the carcass and the tread band, a tension is exerted in the longitudinal direction of the tread band which is held constant during the application of the tread band onto the carcass. In this manner, the occurrence of relative movement between the outer surface of the carcass and the tread band during the application of the tread band is, for all practical purposes, avoided. Due to the initial rotation of the carcass, the forward end of the tread band, as viewed with respect to the tread band which is under tension, is drawn downwardly which thereby effects as well the downward movement of the flanks of the tread band and the application thereof in the desired manner onto the carcass shoulders. This is of particular interest in that contact initially in the tread surface region and thereafter in the shoulder region is the typical application pattern. In accordance with the present invention, the air which is typically present is thereby automatically pushed outwardly so that no included air pockets occur.

Further advantages, details and features of the present invention are described in the hereinafter following description of one embodiment of the present invention taken in conjunction with the sole figure of the drawing.

### BRIEF DESCRIPTION OF THE DRAWING

The sole figure of the drawing is a schematic side elevational view of one embodiment of the tread band application apparatus of the present invention.

### DETAILED DESCRIPTION OF THE PREFERRED EMBODIMENT

As seen in the sole figure of the drawing, a tread band application apparatus 10 comprises a carcass 12. The carcass is supported in a tensioned manner by a carcass support frame 14 and is secured thereby for driving rotation of the carcass. A tread band 16 is to be applied onto the carcass 12, whereby a tread band feed device 18 of the present invention is provided, which includes a pressing device 20 in the form of a clamp is provided which holds fast the forward end 22 of the tread band 16 onto the carcass.

In accordance with the present invention, another component of the tread band application apparatus 10 in the form of a clamp 26 is secured on the rearward end 24 of the tread band 16. The clamp 26 is clamped to, and moves along with, the tread band and holds the tread band under tension during rotation of the carcass 12. In the operation step of the tread band application process shown in the sole figure of the drawing, it can be seen that the carcass has already been rotated through 90°. To dispose the tread band onto the carcass, the pressing device 20 is initially loosened by raising a lever 28 into a raised position relative to the tread band 16. This permits a push guide feed 30, which is supported on the carcass support frame 14, to exert a push force. In this operational condition, the tread band 16 with its forward end 22 is disposed on the carcass 12 at a contact point 32 between the tread band 16 and the carcass 12. Thereafter, the pressing device 20 is activated via the push guide 30 so that the clamp 20 fixedly secures the tread band 16.

The tread band 16 is provided on its underside with a binding rubber layer 34 which ensures the interconnection between the carcass 12 and the tread band 16. As soon as the pressing device 20 is activated, the rearward end 24 of the tread band 16, which is clamped by the clamp 26, is disposed in tension. In this connection, a spiral spring 36 is provided which holds the tread band in uniform tension at least around the carcass circumference.

The clamp 26 is configured as a double working clamp which extends substantially over the width of the tread band 16 but which, however, does not engage the wings or side extents of the tread band for the reason that this structure cannot be heavily loaded. The clamp 26 applies a compressive force via the pressed surfaces 38 to the overside and underside of the tread band.

As soon as the predetermined tension is applied via the spiral spring 36, the carcass 12 is rotated and the forward end 22 of the tread band, which is clamped by the clamp 20, moves in an arcuate manner until the position illustrated in the sole figure of the drawing is reached. Thereafter, the rotation of the carcass 12 via the carcass support frame 14 is continued until the clamp 26 has reached the area of the contact point 32.

The tread band 16 has a length which is chosen such that, in the tensioned condition of the tread band, the tread band is precisely accommodated around the carcass 12. In this manner, a predetermined over mass is provided in that tread bands have a tendency to contract in the event of a reduction of the applied tension. The adhesive effect of the binding rubber layer 34 works against this phenomenon and the dimensioning of the tread band 16 relative to the carcass is preferably provided such that the tread band 16 extends fully around the carcass 12 upon the removal of the clamping force by the clamps 20 and 26.

It is to be understood that the dimensioning of the deployed spring force is accommodated to the operational requirements. For example, for a given tire size, tread bands can be pre-fabricated which each have the same length. The carcass onto which the tread bands are to be applied is then, for example, monitored via a measuring roller in order to determine its exact circumference. In this connection, the spring force of the tension device is adjusted in correspondence with the tread bands to be applied so that the pattern tolerances of the carcasses can be compared to one another.

The method and apparatus of the present invention are particularly suited for tire retreading operations, as pattern fluctuations constantly occur in such operations due to the grinding off of the previous tread from the tire carcass which is to be retreaded, and, in accordance with the present invention, the tread bands 16 can be applied at predetermined locations onto the carcass.

The specification incorporates by reference the disclosure of German priority document 100 38 471.4 of Aug. 7, 2000.

The present invention is, of course, in no way restricted to the specific disclosure of the specification and drawing, but also encompasses any modifications within the scope of the appended claims.

What I claim is:

1. A method for applying a tread band onto a tire carcass, comprising:
disposing the tire carcass on a carcass support frame which supports the tire carcass for driving rotation thereof during the application of a tread band thereonto;
feeding a tread band onto the tire carcass via a tread band feed device while the tire carcass is rotated and in conjunction with the pressing of the tread band against the tire carcass by a pressing device, the feeding of the tread band including feeding a tread band whose length before its application onto the tire carcass is relatively less than its length following the application thereof onto the tire carcass and, during the application of the tread band onto the tire carcass, exerting a tension force on the tread band via at least one clamp clamped on the rearward end of the tread band to produce thereby a tension in the tread band which is maintained during the application of the tread band onto the tire carcass.

2. A method according to claim 1, wherein the tread band is placed in tension between its forward end which is compressively engaged by a clamp and its rearward end which is compressively engaged by a clamp.

3. A method according to claim 1, wherein at least two clamps are disposed for clamping engagement of the rearward end of the tread band which extend beyond from the side edges of the tread band to compressively engage the tread band.

4. A method according to claim 1, wherein the tread band at its rearward end is clamped in a substantially uniform compressive manner across its entire width.

5. A method according to claim 1, wherein the tension exerted on the tread band during the application thereof onto the tire carcass is maintained substantially constant.

6. A method according to claim 1, wherein the force exerted by the clamps on the tread band to produce tension thereon is monitored by a control circuit which controls the tension to be maintained within a fluctuation range of less than 20% and, especially, less than 10%, from a constant tension value.

7. A method according to claim 1, wherein the clamp which applies a clamping pressure on the rearward end of the tread band is carried therealong by the tread band and maintains the tread band in a uniform tension.

8. A method according to claim 1, wherein, during the application of the tread band onto the carcass, the forward end of the tread band is pressed onto the carcass and the carcass is rotated while the clamp applying a clamping pressure on the rearward end of the tread band is moved by movement of the tread band and, in particular, without the application of additional force to the contact point between the tire carcass and the tread band.

9. A tread band application apparatus, comprising:
a rotatively supported carcass onto which a tread and is applied;
a pressing device;
a tread band feed device, the tread band being pressed at its forward end by the pressing device onto the carcass and the tread band being compressively engagable by a clamp at its rearward end, whereby the tread band is maintained under tension during rotation of the carcass.

10. A tread band application apparatus according to claim 9, wherein a control device is provided which maintains the tread band at a predetermined tension during its application onto the carcass and ensures that the tread band is wound onto a predetermined location on the carcass.
